(19) United States
(12) Patent Application Publication
(10) Pub. No.: US 2019/0179647 A1
(43) Pub. Date: Jun. 13, 2019

(54) AUTO THROTTLING OF INPUT DATA AND DATA EXECUTION USING MACHINE LEARNING AND ARTIFICIAL INTELLIGENCE

(71) Applicant: General Electric Company, Schenectady, NY (US)

(72) Inventors: Partha Pritam DEKA, San Ramon, CA (US); Jibin Joseph PULIKHEEL, San Ramon, CA (US)

(21) Appl. No.: 15/840,324

(22) Filed: Dec. 13, 2017

(51) Int. Cl. G06F 9/44; G06N 99/00; G06N 5/04

(52) U.S. Cl. CPC G06F 9/4436; G06N 5/04; G06N 99/005

(57) ABSTRACT

A method is for setting processing parameters for execution of an application program that runs on a multi-processor data processing system. Reinforcement learning is applied to sequentially propose configuration states for executing the application program. Each of the configuration states consists of: (a) a number of instances of the application program; (b) a number of dedicated processors; and (c) a quantity of dedicated memory. The reinforcement learning is allowed to reach an optimal configuration state. The application program is executed in the data processing system in accordance with the optimal configuration state.

### BACKGROUND

Industrial equipment or assets, generally, are engineered to perform particular tasks as part of a business process. For example, industrial assets can include, among other things and without limitation, manufacturing equipment on a production line, wind turbines that generate electricity on a wind farm, healthcare or imaging devices (e.g., X-ray or MRI systems) for use in patient care facilities, or drilling equipment for use in mining operations. The design and implementation of these assets often takes into account both the physics of the task at hand, as well as the environment in which such assets are configured to operate.

Low-level software and hardware-based controllers have long been used to drive industrial assets. However, the rise of inexpensive cloud computing, increasing sensor capabilities, and decreasing sensor costs, as well as the proliferation of mobile technologies have created opportunities for creating novel industrial assets with improved sensing technology that are capable of transmitting data that can then be transmitted to a network and processed by computing resources, such as so-called “cloud” computing resources. As a consequence, there are new opportunities to enhance the business value of some industrial assets using novel industrial-focused hardware and software, while making use of large-scale installations of computing resources.

Issues that arise when an large scale application program is to be run in a cloud computing environment (or in another large, complex installation of computing resources) include (a) in what quantities and at what timing is the input data to be supplied for consumption or processing, and (b) what computing resources need to be allocated to the application program to allow for efficient execution of the application program.

Typically, decision-making to resolve these issues relies on human judgment based on experience with similar applications and/or similar installations of computing resources. It is not uncommon for the results of the decision-making to produce less-than-optimal outcomes.

### BRIEF DESCRIPTION OF THE DRAWINGS

FIG. 1 illustrates generally an example of portions of a first asset management platform (AMP).

FIGS. 2 and 3 are flow charts that illustrate processes performed according to some embodiments.

FIGS. 4, 5, 6, 7 and 8 are functional block diagrams that schematically illustrate some embodiments.

FIG. 9 is a block diagram of a computing system according to some embodiments.

### DETAILED DESCRIPTION

While progress with industrial equipment automation has been made over the last several decades, and assets have become ‘smarter,’ the intelligence of any individual asset pales in comparison to intelligence that can be gained when multiple smart devices are connected together. Aggregating data collected from or about multiple assets can enable users to improve business processes, for example by improving effectiveness of asset maintenance or improving operational performance if appropriate industrial-specific data collection and modeling technology is developed and applied.

In an example, an industrial asset can be outfitted with one or more sensors configured to monitor respective ones of an asset's operations or conditions. Data from the one or more sensors can be recorded or transmitted to a cloud-based or other remote computing environment. By bringing such data into a cloud-based computing environment, new software applications informed by industrial process, tools and know-how can be constructed, and new physics-based analytics specific to an industrial environment can be created. Insights gained through analysis of such data can lead to enhanced asset designs, or to enhanced software algorithms for operating the same or similar asset at its edge, that is, at the extremes of its expected or available operating conditions.

The systems and methods for managing industrial assets can include or can be a portion of an Industrial Internet of Things (IIoT). In an example, an IIoT connects industrial assets, such as turbines, jet engines, and locomotives, to the Internet or cloud, or to each other in some meaningful way. The systems and methods described herein can include using a “cloud” or remote or distributed computing resource or service. The cloud can be used to receive, relay, transmit, store, analyze, or otherwise process information for or about one or more industrial assets. In an example, a cloud computing system includes at least one processor circuit, at least one database, and a plurality of users or assets that are in data communication with the cloud computing system. The cloud computing system can further include or can be coupled with one or more other processor circuits or modules configured to perform a specific task, such as to perform tasks related to asset maintenance, analytics, data storage, data exchange, security, or some other function.

However, the integration of industrial assets with the remote computing resources to enable the IIoT often presents technical challenges separate and distinct from the specific industry and from computer networks, generally. A given industrial asset may need to be configured with novel interfaces and communication protocols to send and receive data to and from distributed computing resources. Given industrial assets may have strict requirements for cost, weight, security, performance, signal interference, and the like such that enabling such an interface is rarely as simple as combining the industrial asset with a general purpose computing device.

To address these problems and other problems resulting from the intersection of certain industrial fields and the IIoT, embodiments may enable improved interfaces, techniques, protocols, and algorithms for facilitating communication with and configuration of industrial assets via remote computing platforms and frameworks. Improvements in this regard may relate to both improvements that address particular challenges related to particular industrial assets (e.g., improved aircraft engines, wind turbines, locomotives, medical imaging equipment) that address particular problems related to use of these industrial assets with these remote computing platforms and frameworks, and also improvements that address challenges related to operation of the platform itself to provide improved mechanisms for configuration, analytics, and remote management of industrial assets as well as distribution of resulting data to individuals who work with or need data generated by industrial assets.

The Predix™ platform available from GE is a novel embodiment of such Asset Management Platform (AMP) technology enabled by state of the art cutting edge tools and cloud computing techniques that enable incorporation of a manufacturer's asset knowledge with a set of development tools and best practices that enables asset users to bridge gaps between software and operations to enhance capabilities, foster innovation, and ultimately provide economic value. Through the use of such a system, a manufacturer of industrial assets can be uniquely situated to leverage its understanding of industrial assets themselves, models of such assets, and industrial operations or applications of such assets, to create new value for industrial customers through asset insights.

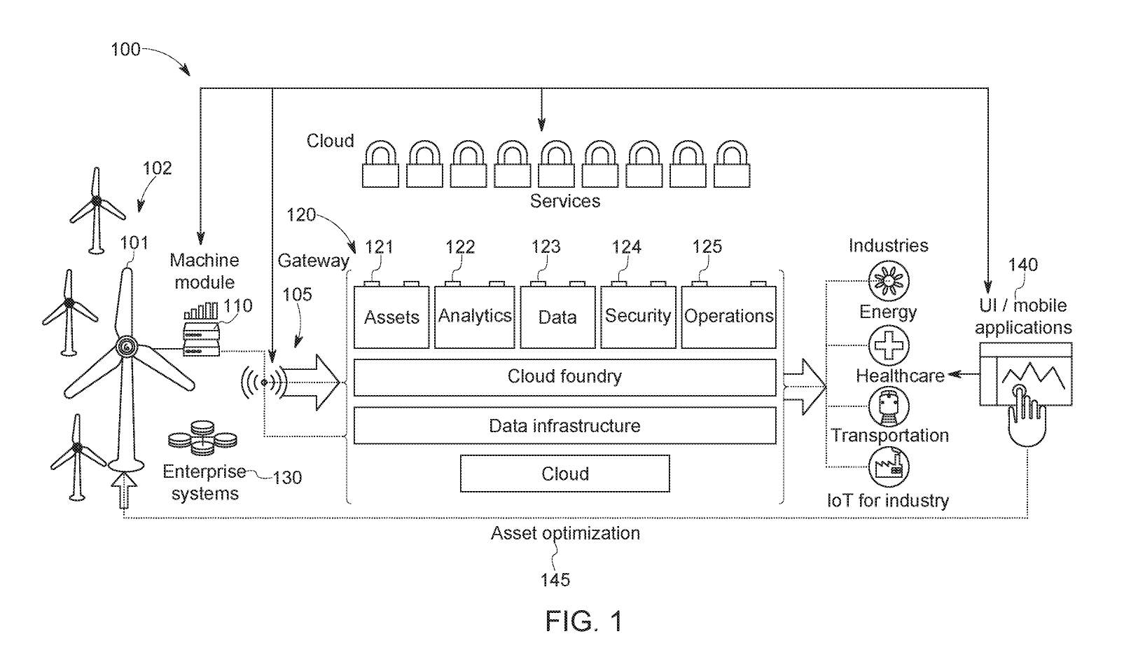

FIG. 1 illustrates generally an example of portions of a first AMP 100. As further described herein, one or more portions of an AMP can reside in an asset cloud computing system 120, in a local or sandboxed environment, or can be distributed across multiple locations or devices. An AMP can be configured to perform any one or more of data acquisition, data analysis, or data exchange with local or remote assets, or with other task-specific processing devices.

The first AMP 100 includes a first asset community 102 that is communicatively coupled with the asset cloud computing system 120. In an example, a machine module 110 receives information from, or senses information about, at least one asset member of the first asset community 102, and configures the received information for exchange with the asset cloud computing system 120. In an example, the machine module 110 is coupled to the asset cloud computing system 120 or to an enterprise computing system 130 via a communication gateway 105.

In an example, the communication gateway 105 includes or uses a wired or wireless communication channel that extends at least from the machine module 110 to the asset cloud computing system 120. The asset cloud computing system 120 includes several layers. In an example, the asset cloud computing system 120 includes at least a data infrastructure layer, a cloud foundry layer, and modules for providing various functions. In the example of FIG. 1, the asset cloud computing system 120 includes an asset module 121, an analytics module 122, a data acquisition module 123, a data security module 124, and an operations module 125. (In some embodiments, the asset cloud computing system may also include a data distribution module—not separately shown—which may at least partially overlap with the data acquisition module 123.) Each of the modules 121-125 includes or uses a dedicated circuit, or instructions for operating a general purpose processor circuit, to perform the respective functions. In an example, the modules 121-125 are communicatively coupled in the asset cloud computing system 120 such that information from one module can be shared with another. In an example, the modules 121-125 are co-located at a designated datacenter or other facility, or the modules 121-125 can be distributed across multiple different locations.

An interface device 140 can be configured for data communication with one or more of the machine module 110, the gateway 105, or the asset cloud computing system 120. The interface device 140 can be used to monitor or control one or more assets. In an example, information about the first asset community 102 is presented to an operator at the interface device 140. The information about the first asset community 102 can include information from the machine module 110, or the information can include information from the asset cloud computing system 120. In an example, the information from the asset cloud computing system 120 includes information about the first asset community 102 in the context of multiple other similar or dissimilar assets, and the interface device 140 can include options for optimizing one or more members of the first asset community 102 based on analytics performed at the asset cloud computing system 120.

In an example, an operator selects a parameter update for the first wind turbine 101 using the interface device 140, and the parameter update is pushed to the first wind turbine via one or more of the asset cloud computing system 120, the gateway 105, and the machine module 110. In an example, the interface device 140 is in data communication with the enterprise computing system 130 and the interface device 140 provides an operation with enterprise-wide data about the first asset community 102 in the context of other business or process data. For example, choices with respect to asset optimization can be presented to an operator in the context of available or forecasted raw material supplies or fuel costs. In an example, choices with respect to asset optimization can be presented to an operator in the context of a process flow to identify how efficiency gains or losses at one asset can impact other assets. In an example, one or more choices described herein as being presented to a user or operator can alternatively be made automatically by a processor circuit according to earlier-specified or programmed operational parameters. In an example, the processor circuit can be located at one or more of the interface device 140, the asset cloud computing system 120, the enterprise computing system 130, or elsewhere.

Returning again to the example of FIG. 1, some capabilities of the first AMP 100 are illustrated. The example of FIG. 1 includes the first asset community 102 with multiple wind turbine assets, including the first wind turbine 101. Wind turbines are used in some examples herein as non-limiting examples of a type of industrial asset that can be a part of, or in data communication with, the first AMP 100.

In an example, the multiple turbine members of the asset community 102 include assets from different manufacturers or vintages. The multiple turbine members of the asset community 102 can belong to one or more different asset communities, and the asset communities can be located locally or remotely from one another. For example, the members of the asset community 102 can be colocated on a single wind farm, or the members can be geographically distributed across multiple different farms. In an example, the multiple turbine members of the asset community 102 can be in use (or non-use) under similar or dissimilar environmental conditions, or can have one or more other common or distinguishing characteristics.

FIG. 1 further includes the device gateway 105 configured to couple the first asset community 102 to the asset cloud computing system 120. The device gateway 105 can further couple the asset cloud computing system 120 to one or more other assets or asset communities, to the enterprise computing system 130, or to one or more other devices, including mobile devices. The first AMP 100 thus represents a scalable industrial solution that extends from a physical or virtual asset (e.g., the first wind turbine 101) to a remote asset cloud computing system 120. The asset cloud computing system 120 optionally includes a local, system, enterprise, or global computing infrastructure that can be optimized for industrial data workloads, secure data communication, and compliance with regulatory requirements.

In an example, information from an asset, about the asset, or sensed by an asset itself is communicated from the asset to the data acquisition module 124 in the asset cloud computing system 120. In an example, an external sensor can be used to sense information about a function of an asset, or to sense information about an environment condition at or near an asset. The external sensor can be configured for data communication with the device gateway 105 and the data acquisition module 124, and the asset cloud computing system 120 can be configured to use the sensor information in its analysis of one or more assets, such as using the analytics module 122.

In an example, the first AMP 100 can use the asset cloud computing system 120 to retrieve an operational model for the first wind turbine 101, such as using the asset module 121. The model can be stored locally in the asset cloud computing system 120, or the model can be stored at the enterprise computing system 130, or the model can be stored elsewhere. The asset cloud computing system 120 can use the analytics module 122 to apply information received about the first wind turbine 101 or its operating conditions (e.g., received via the device gateway 105) to or with the retrieved operational model. Using a result from the analytics module 122, the operational model can optionally be updated, such as for subsequent use in optimizing the first wind turbine 101 or one or more other assets, such as one or more assets in the same or different asset community. For example, information about the first wind turbine 101 can be analyzed at the asset cloud computing system 120 to inform selection of an operating parameter for a remotely located second wind turbine that belongs to a different second asset community.

The first AMP 100 includes a machine module 110. The machine module 110 includes a software layer configured for communication with one or more industrial assets and the asset cloud computing system 120. In an example, the machine module 110 can be configured to run an application locally at an asset, such as at the first wind turbine 101. The machine module 110 can be configured for use with or installed on gateways, industrial controllers, sensors, and other components. In an example, the machine module 110 includes a hardware circuit with a processor that is configured to execute software instructions to receive information about an asset, optionally process or apply the received information, and then selectively transmit the same or different information to the asset cloud computing system 120.

In an example, the asset cloud computing system 120 can include the operations module 125. The operations module 125 can include services that developers can use to build or test Industrial Internet applications, or the operations module 125 can include services to implement Industrial Internet applications, such as in coordination with one or more other AMP modules. In an example, the operations module 125 includes a microservices marketplace where developers can publish their services and/or retrieve services from third parties. The operations module 125 can include a development framework for communicating with various available services or modules. The development framework can offer developers a consistent look and feel and a contextual user experience in web or mobile applications.

In an example, an AMP can further include a connectivity module. The connectivity module can optionally be used where a direct connection to the cloud is unavailable. For example, a connectivity module can be used to enable data communication between one or more assets and the cloud using a virtual network of wired (e.g., fixed-line electrical, optical, or other) or wireless (e.g., cellular, satellite, or other) communication channels. In an example, a connectivity module forms at least a portion of the gateway 105 between the machine module 110 and the asset cloud computing system 120, and/or between the asset cloud computing system 120 and other components of the AMP 100, including for example mobile devices (as discussed below) and/or fixed-location data-receiving devices.

In an example, an AMP can be configured to aid in optimizing operations or preparing or executing predictive maintenance for industrial assets. An AMP can leverage multiple platform components to predict problem conditions and conduct preventative maintenance, thereby reducing unplanned downtimes. In an example, the machine module 110 is configured to receive or monitor data collected from one or more asset sensors and, using physics-based analytics (e.g., finite element analysis or some other technique selected in accordance with the asset being analyzed), detect error conditions based on a model of the corresponding asset. In an example, a processor circuit applies analytics or algorithms at the machine module 110 or at the asset cloud computing system 120.

In response to the detected error conditions, the AMP can issue various mitigating commands to the asset, such as via the machine module 110, for manual or automatic implementation at the asset. In an example, the AMP can provide a shut-down command to the asset in response to a detected error condition. Shutting down an asset before an error condition becomes fatal can help to mitigate potential losses or to reduce damage to the asset or its surroundings. In addition to such an edge-level application, the machine module 110 can communicate asset information to the asset cloud computing system 120.

In an example, the asset cloud computing system 120 can store or retrieve operational data for multiple similar assets. Over time, data scientists or machine learning can identify patterns and, based on the patterns, can create improved physics-based analytical models for identifying or mitigating issues at a particular asset or asset type. The improved analytics can be pushed back to all or a subset of the assets, such as via multiple respective machine modules 110, to effectively and efficiently improve performance of designated (e.g., similarly-situated) assets.

In an example, the asset cloud computing system 120 includes a Software-Defined Infrastructure (SDI) that serves as an abstraction layer above any specified hardware, such as to enable a data center to evolve over time with minimal disruption to overlying applications. The SDI enables a shared infrastructure with policy-based provisioning to facilitate dynamic automation, and enables SLA (service level agreement) mappings to underlying infrastructure. This configuration can be useful when an application requires an underlying hardware configuration. The provisioning management and pooling of resources can be done at a granular level, thus allowing optimal resource allocation.

In a further example, the asset cloud computing system 120 is based on Cloud Foundry (CF), an open source PaaS (Platform-as-a-Service) that supports multiple developer frameworks and an ecosystem of application services. Cloud Foundry can make it faster and easier for application developers to build, test, deploy, and scale applications. Developers thus gain access to the vibrant CF ecosystem and an ever-growing library of CF services. Additionally, because it is open source, CF can be customized for IIoT workloads.

The asset cloud computing system 120 can include a data services module that can facilitate application development. For example, the data services module can enable developers to bring data into the asset cloud computing system 120 and to make such data available for various applications, such as applications that execute at the cloud, at a machine module, or at an asset or other location (such as a mobile device). In an example, the data services module can be configured to cleanse, merge, or map data before ultimately storing it in an appropriate data store, for example, at the asset cloud computing system 120. A special emphasis has been placed on time series data, as it is the data format that most sensors use.

Security can be a concern for data services that deal in data exchange between the asset cloud computing system 120 and one or more assets or other components. Some options for securing data transmissions include using Virtual Private Networks (VPNs) or an SSL/TLS (secure socket layer/transport layer security) model. In an example, the first AMP 100 can support two-way TLS, such as between a machine module and the security module 124. In an example, two-way TLS may not be supported, and the security module 124 can treat client devices as OAuth users. For example, the security module 124 can allow enrollment of an asset (or other device) as an OAuth client and transparently use OAuth access tokens to send data to protected endpoints.

In some examples, the cloud computing system 120 may include dozens, hundreds or even thousands of interconnected processors and/or server computers.

In some examples, dynamic auto scaling is applied with regard to consumption and execution of data points. This may enable deployment of large scale applications and memory/CPU intensive algorithms in any environment, including the cloud computing system 120, without specifying the resource requirements of the application. The process employed as to data consumption may use a supervised learning regression algorithm to learn (be trained on) historical rate and volume of data consumption by previously run applications and then to predict the rate of data flow into the processing channel based on input data rate and volume. The process employed as to data execution may employ self-learning/artificial intelligence based reinforcement learning techniques to identify the required number of optimal resources autonomously without hampering performance in the execution of the application.

In some examples, there are two aspects of auto scaling that may be employed. A first aspect may relate to data consumption. This aspect may allow data to be consumed from multiple source systems. The source systems may include, for example, continuous streams of real time data, unstructured file data, and/or data from one or more traditional relational database management systems. The process for consuming the data from multiple systems may be dynamically managed and auto scaled based on the rate of data being generated as well as the volume. The system may use a supervised learning regression algorithm. The supervised learning regression algorithm may learn on historical rate and volume of the data along with the output (rate of data flow into the data processing channel). The historical data may have been collected or may be collected from various cloud based data consumption applications, with the input features being the rate of data generated and volume of data, and the label is the rate of consumption of data or the rate of flow into the data processing channel. For example, the label could be or include the minimum timeframe of data splits generated by a data splitter application. To give a more concrete example, without limitation, a source system may generate 10 kb of data per second and the overall volume of data to be accumulated and processed may be for six months (corresponding to 100 GB of data). The data splitter application, in this example, makes data splits of 5 minutes each. The trained supervised model is then used to predict the rate of data flow into the data processing channel based on current inputs—the input data rate and the volume of data.

A second aspect of auto scaling may relate to data execution. This aspect allows data to be executed in the pipeline. The process for executing the data is managed by dynamically controlling the number of instances of the application, the quantity of memory to be provided and the number of CPUs (also referred to as “processors”) to be utilized. The dynamic control process is carried out via reinforcement learning. Reinforcement learning is a form of self-learning process that creates policies that provide specific direction on the action to be taken by the self-learning process. Reinforcement learning involves a solution of the Markov Decision Problem. A reinforcement learning system can be analogized to a suitably programmed robot that senses its environment and takes action. For present purposes the environment is the quantity of data chunks or splits (e.g., as determined according to the above-described data consumption aspect) and the rate or speed at which these data chunks need to be processed. Based on the environment, the self-learning system takes action. In accordance with this action, a number of instances of the application, a quantity of memory and a number of CPUs are specified. The self-learning system determines the action based on the policy, and upon taking the action, transitions to a new state—i.e., the state defined by the number of instances, number of CPUs and quantity of memory. This can be considered a recursive process in which an action “a” is taken and the environment transitions to a new state based on a transition function “T”. The self-learning system looks up the policy “Pi” and takes a new action. The self-learning system finds the most optimal policy to take the optimal action over time using the concept of “Q” learning. Q learning is reward based learning where for every action the self-learning system is discounted or rewarded. The goal of the self-learning system is to find the optimal policy over time that would maximize the reward over time. Key aspects of the self-learning process include the following:

Environment (E)—the quantity of data chunks or splits and rate of speed at which the data chunks need to be processed.

Transition function (T)—the function that transitions to a new state based on the action in the current state.

Reward function (R)—the reward associated with each state.

Policy function (Pi)—what action to take in a given state.

The optimal policy (Q)—the policy that maximizes the reward by transitioning to a new state based on the action in the current state.

State (s)—in this example embodiment, the state is defined by the number of instances of the application, the number of CPUs and the quantity of memory.

The formula for computing Q for any state-action pair <s, a>, given an experience tuple <s, a, s′, r> is:

Q′[s,a]=(1−α)·Q[s,a]+α·(r+γ·Q[s′,argmax a′(Q[s′,a′])]) (Equation 1)
where:
s is a current state;
a is an action to be taken to transition to a next state s′;
Q′ is a recursively calculated measure of optimization corresponding to an experience tuple <s, a, s′, r>;
r=R[s, a] is the immediate reward for taking action a in state s;
γ∈[0, 1] (gamma) is the discount factor used to progressively reduce the value of future rewards;
s′ is the resulting next state;
argmax a′(Q[s′, a′]) is the action that maximizes the Q-value among all possible actions a′ from s′; and
α∈[0, 1] (alpha) is the learning rate used to vary the weight given to new experiences compared with past Q-values.

In some examples, the quantity of memory, the number of CPUs and the number of instances of the application are adjusted to arrive at a “ratio of optimization”, which experience has shown can be satisfied by satisfying the following statement:

3≤(I/(M×C))≤5;
wherein:
   I is the number of instances of the application program:
   M is the quantity of dedicated memory in gb; and
   C is the number of dedicated processors.

This can also be expressed by stating the ratio of the number of instances to the product of memory (in gb) and number of CPUs is to be in a range between 3 and 5, inclusive. To give one specific numerical example, without limitation, the optimal state reached by the self-learning may be a configuration of 150 instances of the application, 10 gb memory, and 3 CPUs. The calculation of the ratio is thus 150/(10×3)=5, which is within the range set according to aspects of this embodiment.

In some embodiments, the data consumption aspect of the auto scaling may be used to generate reports with statistics regarding each run, where the statistics may include resources utilized and processing time. It may be contemplated that the report or reports be used by developers and data scientists to cross validate resource utilization and expected performance.

In some embodiments, the self-learning process may be built in the “Python” programming language. The self-learning process may be configured such that, in building the policy function, it is a requirement that the self-learning process has to go through at least one rewarding example and one discounting example before convergence can be reached.

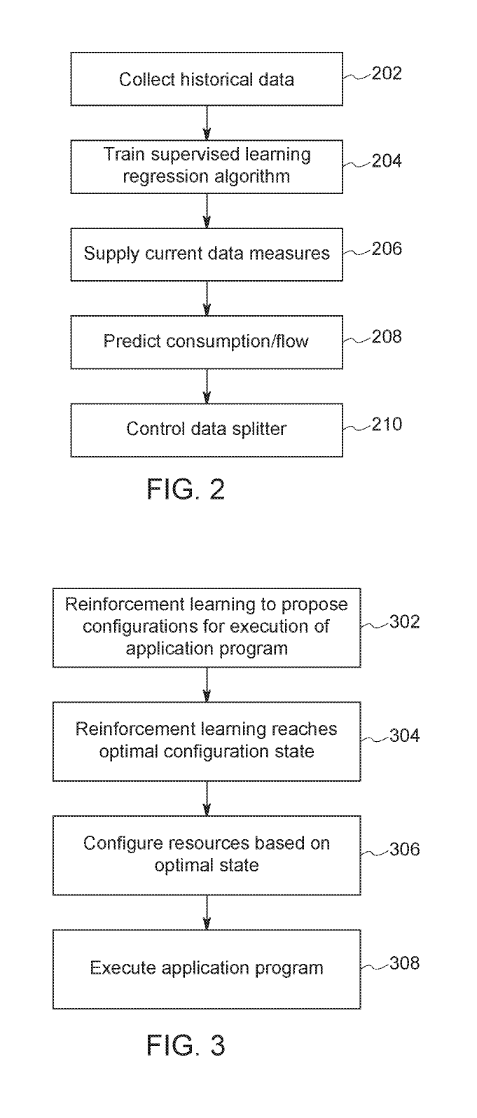

FIG. 2 is a flow chart that illustrates a process performed according to some embodiments.

The process of FIG. 2 is related to the above-mentioned data consumption aspect of auto scaling. At 202 in FIG. 2, historical data is collected. The historical data may relate to operation of a considerable number of application programs that have been run on the cloud computing system 120. The historical data may be structured as triplets of data elements, with the first data element of the triplet being the intake data rate for a particular application run; with the second data element being the intake data volume for the run; and with the third data element being the data consumption rate or the rate of data flow into the processing channel for the run. From prior discussion, it will be appreciated that the third data element may serve as a label for the first two data elements. This data may be collected as a matter of course during operation of the cloud computing system 120 and thus may be readily available.

At 204 in FIG. 2, a supervised learning regression algorithm may be trained on the historical data collected at 202. In an example, the supervised learning regression algorithm may be a gradient boosting regression algorithm. In other examples, other types of regression algorithms may be employed.

At 206 in FIG. 2, the current proposed intake data rate and current proposed intake data volume for the application to be run may be supplied to the trained supervised learning regression algorithm.

At 208, the trained supervised learning regression algorithm may be used to predict a current proposed data consumption rate or a current proposed data flow into the processing channel for the application to be run on the cloud computing system 120. The prediction may be based on the intake data volume and data rate as supplied at 206.

At 210, a data splitter application running on the cloud computing system 120 may be controlled based on the predicted data consumption rate or data flow into the processing channel.

FIG. 3 is a flow chart that illustrates a process performed according to some embodiments.

At 302 in FIG. 3, reinforcement learning is applied to sequentially propose configuration states for execution of an application program in a multi-processor data processing system such as the cloud computing system 120. Each state is defined in terms of: (a) a number of instances of the application program; (b) a quantity of dedicated memory; and (c) a number of dedicated processors. The self-learning process may start from a random state and then transition through a sequence of states to an optimal state. At 304 in FIG. 3, the self-learning process reaches an optimal configuration state. At 306, the resources of the multi-processor data processing system are configured in accordance with the optimal configuration state reached at 304. At 308, the application program is executed on the multi-processor data processing system in accordance with the optimal configuration state reached at 304.

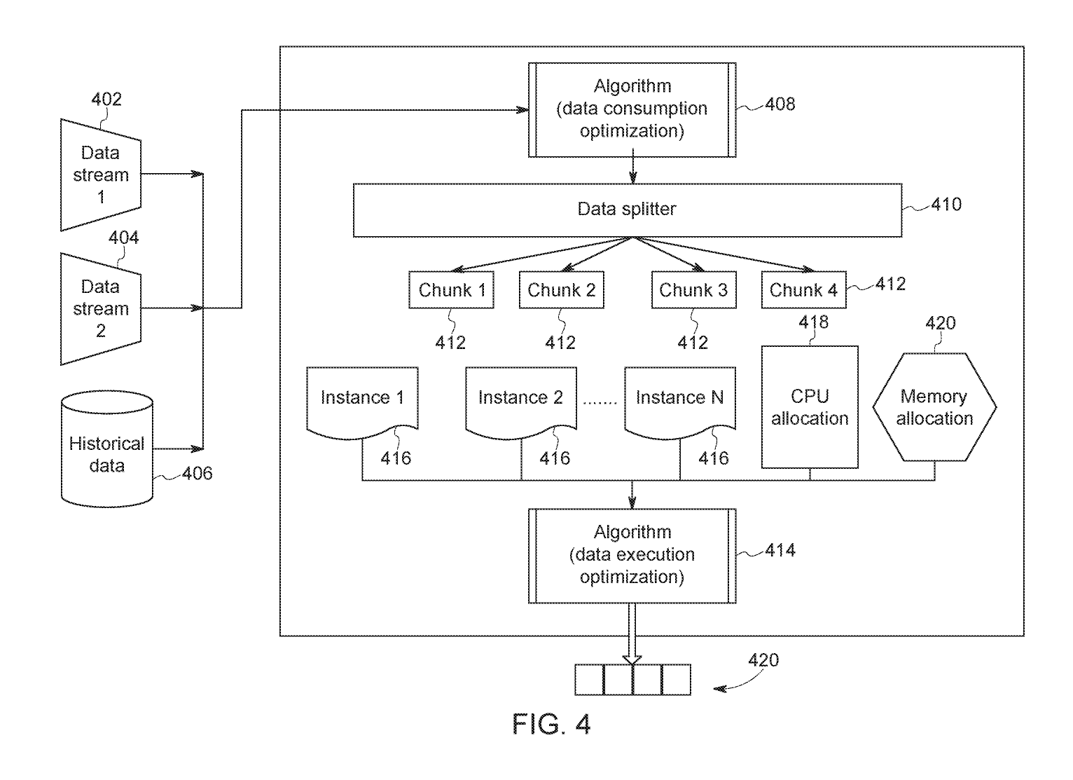

FIG. 4 is a schematic block diagram that illustrates an embodiment as an auto throttling end-to-end process. In FIG. 4, data streams 402 and 404 and historical data 406 are supplied as inputs to a data consumption optimization algorithm 408. Based on an outcome of performing the data consumption optimization algorithm 408, a data splitter application 410 is controlled to output suitably sized data chunks 412 at a suitable timing. A data execution optimization algorithm 414 sets up a system configuration of application instances 416, an allocation of CPUs 418 and a memory allocation 420 to handle data for consumption/processing at 420.

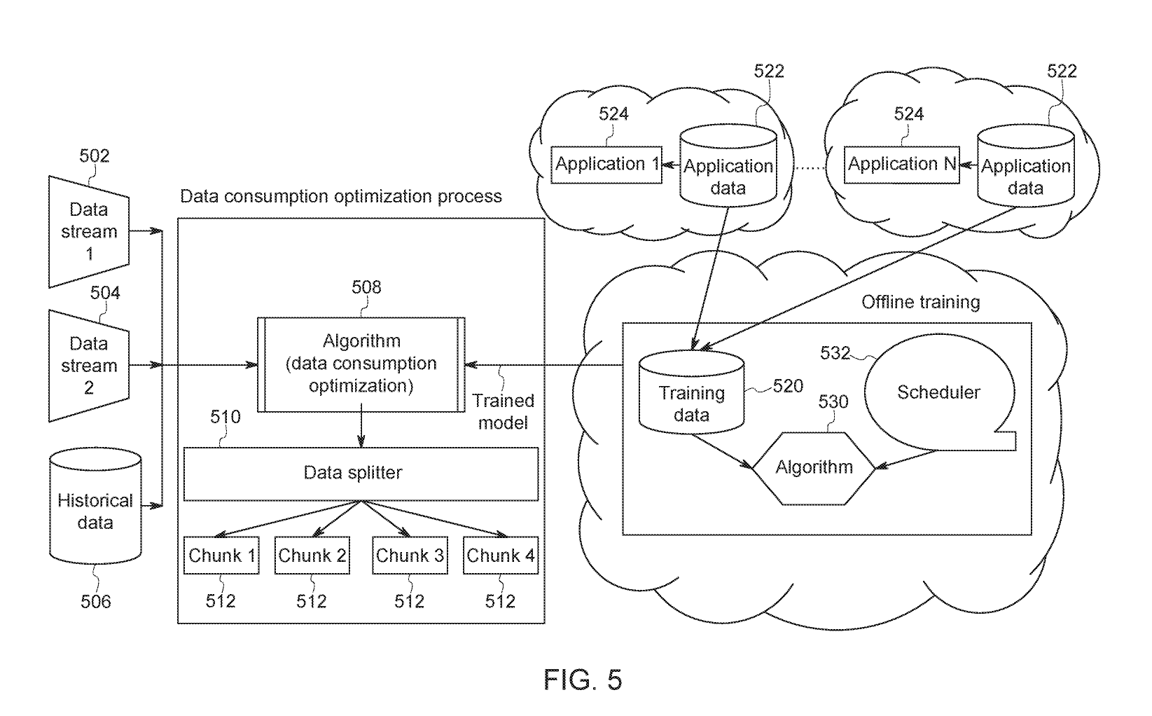

FIG. 5 is a schematic block diagram that illustrates an embodiment viewed as an auto throttling data consumption process. In FIG. 5, data streams 502 and 504 and historical data 506 are supplied as inputs to a data consumption optimization algorithm 508. Based on an outcome of performing the data consumption optimization algorithm 508, a data splitter application 510 is controlled to output suitably sized data chunks 512 at a suitable timing. The useful output from the data consumption optimization algorithm 508 is enabled by offline training of the algorithm 508, as schematically illustrated at the right-hand portion of FIG. 5. A training data set 520 is collected from application data sources 522 that record data relating to operation of applications 524 (e.g., on cloud computing system 120). The algorithm in its training phase is represented at 530 and may operate under control by scheduler 532.

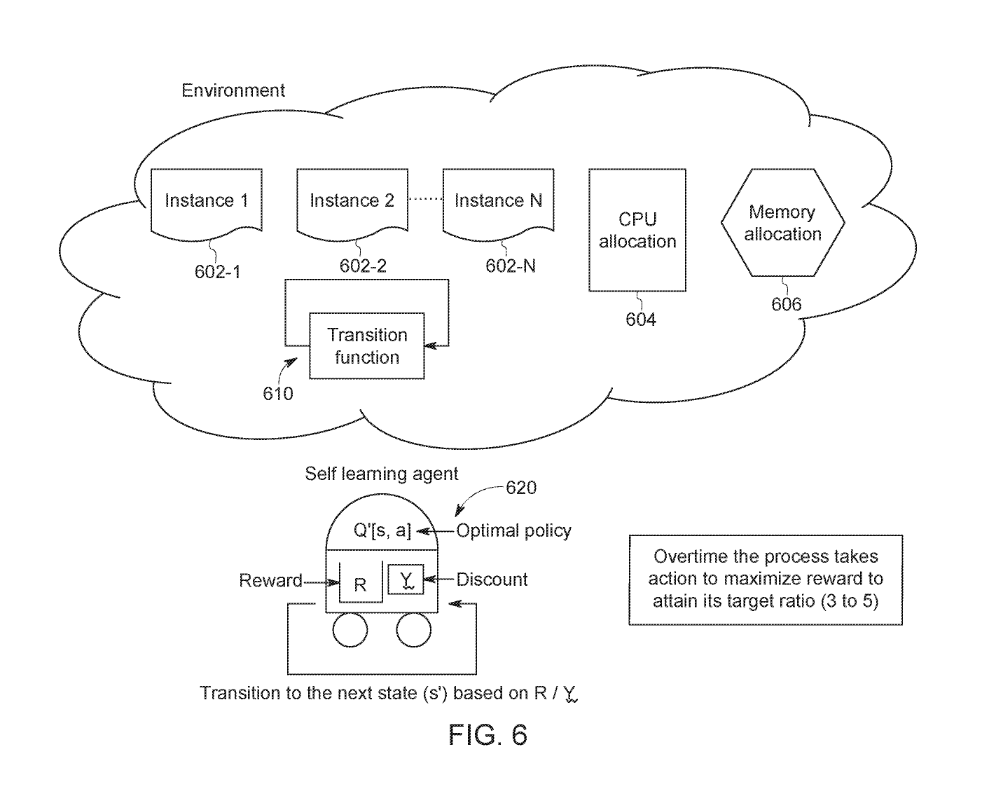

FIG. 6 is a schematic block diagram that illustrates an embodiment viewed as an auto throttling data execution self-learning process. Blocks 602-1, 602-2, 602-N, 604 and 606 together represent a state of the self-learning process. Blocks 602-1, 602-2 and 602-N represent a first attribute of the state, namely a number of instances of the application program that is to be run. Block 604 represents a second attribute of the state, namely an allocation of a number of CPUs, where that number is part of the definition of the state. Block 606 represents a third attribute of the state, namely an allocation of memory, where the allocated quantity of memory (e.g., measured in gb) is part of the definition of the state.

The self-learning process may start at a random state defined by a number of instances, a number of allocated CPUs and an allocated quantity of memory. Via a transition function 610, the self-learning process transitions from state to state. A recursive self-learning agent 620 guides the transition function based on rewards/discounts provided by a policy function. The final state of the self-learning process may satisfy the above-discussed ratio of optimization.

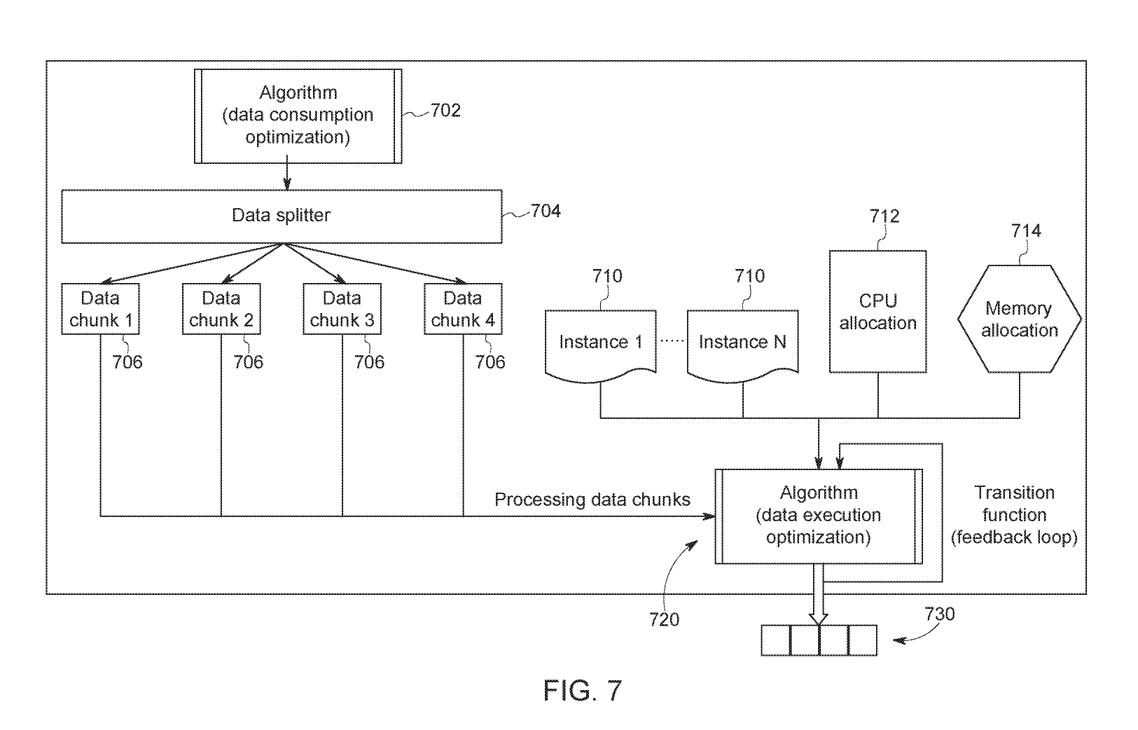

FIG. 7 is a schematic block diagram that illustrates an embodiment viewed as an auto throttling data execution process. A data consumption optimization algorithm 702 provides an outcome that is used to control a data splitter application 704 to output suitably sized data chunks 706. The data chunks 706 are processed by a configuration of processing resources that is defined by N instances 710 of an application program, an allocation 712 of CPUs and an allocation 714 of memory. The configuration represents an optimal state reached by a data execution optimization algorithm 720. The processing configuration produces an output 730.

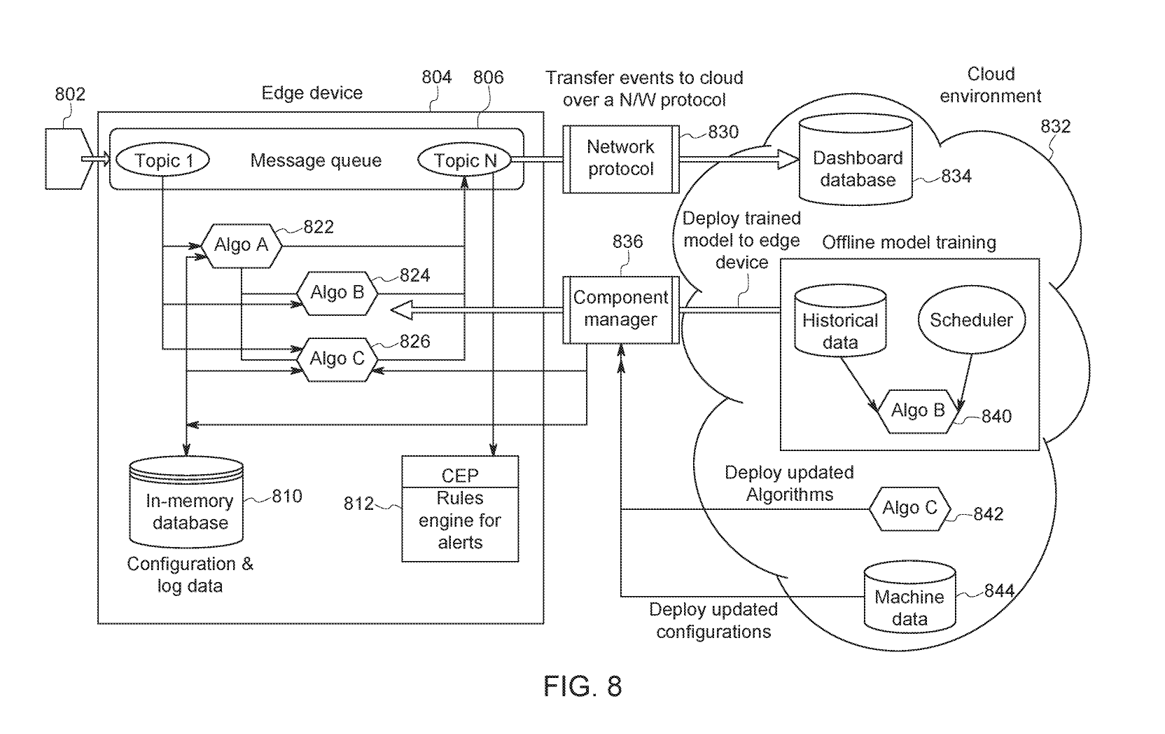

FIG. 8 is a schematic block diagram that illustrates an auto scaling industrial use case embodiment. In FIG. 8, raw sensor data 802 is an input to an edge device 804 and is sorted by the edge device 804 into topics included in a message queue 806. A database 810 stores configuration and log data. A rules engine 812 launches alerts as defined by rules implemented in the rules engine 812. The edge device 804 performs algorithms 822, 824, 826, which may be performed sequentially and/or in parallel relative to each other. The algorithms 822, 824, 826 may subscribe to particular topics in the message queue 806 in order to consume chunks of sensor data. One or more of the algorithms 822, 824, 826 may write log entries to the database 810. One or more of the algorithms 822, 824, 826 may publish events to one or more topics in the message queue 806. One or more of the algorithms 822, 824, 826 may read relevant configurations from the database 810.

Via a network protocol 830, the edge device 804 may transfer events to a cloud environment 832. The events transferred to the cloud environment 832 may be displayed via a database dashboard 834. A component manager 836 may manage exchange of operating/configuration data between the cloud environment 832 and the edge device 804.

A trained model may be deployed to algorithm 824 after offline model training of an instance 840 of the algorithm 824 in the cloud environment 832.

An instance 842 of the algorithm 826 may be updated in the cloud environment 832 and deployed to the edge device 804 via the component manager 836.

Data 844 generated by machine learning in the cloud environment 832 may be employed to transfer updated algorithm configurations to the edge device 804 via the component manager 836.

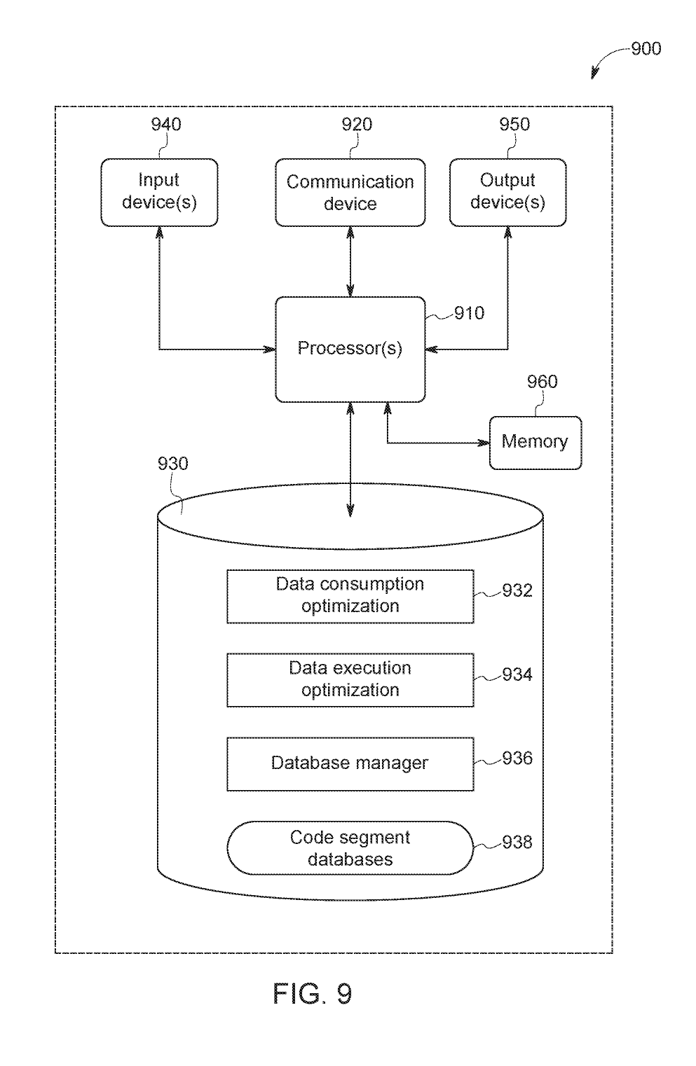

Computer 900 shown in FIG. 9 is an example hardware-oriented representation of computing resources that may be utilized for machine learning and/or artificial intelligence algorithms for auto scaling data compression and/or data execution as described herein. In some embodiments, the computer 900 may be taken as a representation of relevant components of the cloud computing system 120.

Referring to FIG. 9, computer 900 includes one or more processors 910 operatively coupled to communication device 920, data storage device 930, one or more input devices 940, one or more output devices 950 and memory 960. Communication device 920 may facilitate communication with external devices, such as a reporting client, or a data storage device, or a device that is to be configured for data consumption and/or data execution. Input device(s) 940 may include, for example, a keyboard, a keypad, a mouse or other pointing device, a microphone, knob or a switch, an infra-red (IR) port, a docking station, and/or a touch screen. Input device(s) 940 may be used, for example, to enter information into the computer 900. Output device(s) 950 may include, for example, a display (e.g., a display screen), a speaker, and/or a printer.

Data storage device 930 may include any appropriate persistent (i.e., non-transitory) storage device, including combinations of magnetic storage devices (e.g., magnetic tape, hard disk drives and flash memory), optical storage devices, Read Only Memory (ROM) devices, etc., while memory 960 may include Random Access Memory (RAM). The data storage device 930 and the memory 960 may be in communication with each other and/or with the processor(s) 910.

Data storage device 930 may store software programs that include program code executed by processor(s) 910 to cause computer 900 to perform any one or more of the processes described herein. Embodiments are not limited to execution of these processes by a single apparatus. For example, the data storage device 930 may store a data consumption optimization algorithm 932, as described above.

Continuing to refer to FIG. 9, data storage device 930 may also store a data execution optimization algorithm 934, as described above.

Also, data storage device 930 may store a database manager program 936 and one or more databases 938, which may be processed or stored in the computer 900. Data storage device 930 may store other data and other program code for providing additional functionality and/or which are necessary for operation of system computer 900, such as device drivers, operating system files, etc.

A technical effect is to improve the efficiency of allocation of resources for running application programs on large multi-processor computer systems.

The foregoing diagrams represent logical architectures for describing processes according to some embodiments, and actual implementations may include more or different components arranged in other manners. Other topologies may be used in conjunction with other embodiments. Moreover, each system described herein may be implemented by any number of devices in communication via any number of other public and/or private networks. Two or more of such computing devices may be located remote from one another and may communicate with one another via any known manner of network(s) and/or a dedicated connection. Each device may include any number of hardware and/or software elements suitable to provide the functions described herein as well as any other functions. For example, any computing device used in an implementation of some embodiments may include a processor to execute program code such that the computing device operates as described herein.

All systems and processes discussed herein may be embodied in program code stored on one or more non-transitory computer-readable media. Such media may include, for example, a floppy disk, a CD-ROM, a DVD-ROM, a Flash drive, magnetic tape, and solid state Random Access Memory (RAM) or Read Only Memory (ROM) storage units. Embodiments are therefore not limited to any specific combination of hardware and software.

The flow charts and descriptions thereof herein should not be understood to prescribe a fixed order of performing the method steps described therein. Rather the method steps may be performed in any order that is practicable, including simultaneous performance of steps and/or omitting one or more steps.

Embodiments described herein are solely for the purpose of illustration. A person of ordinary skill in the relevant art may recognize other embodiments may be practiced with modifications and alterations to that described above.

What is claimed is:

1. A method comprising:
collecting historical data regarding operation of a plurality of application programs that run on a data processing system, the historical data structured as triplets of data elements, a respective first data element of each triplet of data elements being an intake data rate for a respective one of the application programs, a respective second data element of said each triplet being an intake data volume for the respective one of the application programs, and a third respective data element of said each triplet being a data consumption rate or a rate of data flow into a processing channel being associated with said intake data rate, said intake data volume and said respective application program;
training a supervised learning regression algorithm on said collected historical data;
supplying a current proposed intake data rate and a current proposed intake data volume to the trained supervised learning regression algorithm;
using the trained supervised learning regression algorithm to predict a current proposed data consumption rate or a current proposed data flow into the processing channel based on the supplied current proposed intake data rate and the current proposed intake data volume; and
controlling a data splitter application program based on the predicted current proposed data consumption rate or the predicted current proposed data flow into the processing channel.

2. The method of claim 1, wherein the supervised learning regression algorithm employs gradient boosting regression.

3. The method of claim 1, wherein the data processing system includes a plurality of interconnected server computers.

4. The method of claim 3, wherein the data processing system includes at least 10 interconnected server computers.

5. The method of claim 4, wherein the data processing system includes at least 100 interconnected server computers.

6. A method of setting processing parameters for execution of an application program that runs on a multi-processor data processing system, the method comprising:
applying reinforcement learning to sequentially propose configuration states for executing the application program; each of said configuration states consisting of: (a) a respective number of instances of the application program, (b) a number of dedicated processors, and (c) a quantity of dedicated memory;
allowing the reinforcement learning to reach an optimal configuration state; and
executing the application program in the data processing system in accordance with the optimal configuration state.

7. The method of claim 6, wherein the reinforcement learning is commenced with a random configuration state.

8. The method of claim 7, wherein the reinforcement learning transitions from one of the configuration states to a next one of the configuration states based on references to a policy table.

9. The method of claim 8, wherein the next one of the configuration states is determined based on a state optimization calculation according to the formula:
Q′[s,a]=(1−α)·Q[s,a]+α·(r+γ·Q[s′,argmax a′(Q[s′,a′])])
where:
s is a current state;
a is an action to be taken to transition to a next state s′;
Q′ is a recursively calculated measure of optimization corresponding to an experience tuple <s, a, s′, r>;
r=R[s, a] is the immediate reward for taking action a in state s;
γ∈[0, 1] (gamma) is the discount factor used to progressively reduce the value of future rewards;
s′ is the resulting next state;
argmax a′(Q[s′, a′]) is the action that maximizes the Q-value among all possible actions a′ from s′; and
α∈[0, 1] (alpha) is the learning rate used to vary the weight given to new experiences compared with past Q-values.

10. The method of claim 9, wherein the optimal configuration state satisfies the statement 3≤(I/(M×C))≤5;
wherein, in the optimal configuration state:
I is the number of instances of the application program;
M is the quantity of dedicated memory in gb; and
C is the number of dedicated processors.

11. The method of claim 10, wherein the multi-processor data processing system includes at least 10 processors.

12. The method of claim 11, wherein the multi-processor data processing system includes at least 100 processors.

13. The method of claim 12, wherein the multi-processor data processing system includes at least 1000 processors.

14. An apparatus for setting processing parameters for execution of an application program that runs on a multi-processor data processing system, the apparatus comprising:
a processor; and
a memory in communication with the processor and storing program instructions, the processor operative with the program instructions to perform functions as follows:
applying reinforcement learning to sequentially propose configuration states for executing the application program; each of said configuration states consisting of: (a) a respective number of instances of the application program, (b) a number of dedicated processors, and (c) a quantity of dedicated memory;
allowing the reinforcement learning to reach an optimal configuration state; and
executing the application program in the data processing system in accordance with the optimal configuration state.

15. The apparatus of claim 14, wherein the reinforcement learning is commenced with a random configuration state.

16. The apparatus of claim 15, wherein the reinforcement learning transitions from one of the configuration states to a next one of the configuration states based on references to a policy table.

17. The apparatus of claim 16, wherein the next one of the configuration states is determined based on a state optimization calculation according to the formula:
Q′[s,a]=(1−α)·Q[s,a]+α·(r+γ·Q[s′,argmax a′(Q[s′,a′])])
where:
s is a current state;
a is an action to be taken to transition to a next state s′;
Q′ is a recursively calculated measure of optimization corresponding to an experience tuple <s, a, s′, r>;
r=R[s, a] is the immediate reward for taking action a in state s;
γ∈[0, 1] (gamma) is the discount factor used to progressively reduce the value of future rewards;
s′ is the resulting next state;
argmax a′(Q[s′, a′]) is the action that maximizes the Q-value among all possible actions a′ from s′; and
α∈[0, 1] (alpha) is the learning rate used to vary the weight given to new experiences compared with past Q-values.

18. The apparatus of claim 17, wherein the optimal configuration state satisfies the statement 3≤(I/(M×C))≤5;
wherein, in the optimal configuration state:
I is the number of instances of the application program;
M is the quantity of dedicated memory in gb; and
C is the number of dedicated processors.

19. The apparatus of claim 18, wherein the multi-processor data processing system includes at least 10 processors.

20. The apparatus of claim 19, wherein the multi-processor data processing system includes at least 100 processors.
